(19) United States
(12) Patent Application Publication
(10) Pub. No.: US 2024/0158124 A1
(43) Pub. Date: May 16, 2024

(54) METHOD FOR PLACING A LABEL ON MOULDED PACKAGING, TOOLING FOR IMPLEMENTING SAID METHOD, INSTALLATION COMPRISING SAID TOOLING AND PACKAGING OBTAINED

(71) Applicant: MACHINES PAGES, Foncine-le-Haut (FR)

(72) Inventors: Yannick AINS, La Chaumusse (FR); Philippe OLICHON, Foncine le Haut (FR); Matthias PEREZ, Foncine le Haut (FR); Guy PIERRE, Mouthe (FR)

(21) Appl. No.: 18/550,260

(22) PCT Filed: Mar. 10, 2022
(86) PCT No.: PCT/EP22/56146

§ 371 Date: Sep. 12, 2023

(30) Foreign Application Priority Data
Mar. 12, 2021 (FR) FR2102466

(51) Int. Cl. B65C 3/14; B65C 9/25

(52) U.S. Cl. CPC B65C 3/14; B65C 9/25

(57) ABSTRACT

The method for placing a label on an item of packaging molded from natural fibers includes carrying out the following successive operations. The method includes turning over the packaging, with the opening directed downward, holding the packaging from the inside, positioning and holding the label above the packaging, driving the packaging in movement and bringing the outside of its bottom into contact with the label, stopping holding the label, indexing and securing the label in a spotwise fashion on the bottom, moving the packaging and positioning the bottom thereof next to means for activating a securing process, bringing the bottom and the label into contact with the activation means, activating the process of securing the label, and removing the labeled packaging.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

A method for placing a label on a molded packaging, tooling with which to implement said method, installation comprising said tooling, and resulting packaging.

The subject matter of the present invention is a method for placing a decoration and/or information support label, at least on the bottom of a molded package, implemented in a biodegradable material, of the type comprising a bottom and at least one peripheral wall, and also the tooling allowing implementation of said method, the installation comprising said tooling, and the resulting transformed packaging.

### 2. Description of Related Art Including Information Disclosed Under 37 CFR 1.97 and 37 CFR 1.98

Traditionally, reproduction of information and/or decoration on the package consists of placing on at least one wall thereof, a label adhered or applied by offset or screen printing.

On plastic packages, the labels may be adhesive, or they may be placed in the injection mold for said package according to technology called IML (In Mold Labeling).

For ecological reasons, there is now a trend to replace plastic packages with molded packages of natural fibers, meaning molded of a material comprising natural fibers, where said material may in particular be biodegradable, compostable, such as for example paper pulp.

These packages meet most ecological criteria; however that generates new difficulties. Thus, the surface roughness, irregularity and energy of the wall(s) prevent being able to satisfactorily adhere labels.

To overcome this disadvantage, it is possible to treat the wall(s) of a package of paper pulp for example in order to modify the surface condition, and allow a label to properly adhere; that involves a complex and costly additional step.

It is also possible to use an offset printing method, but the material from which the package is made drinks ink, while here again the irregular surface condition compromises the sharpness of the reproduction.

Further, making deposits on the edges is complex when there are any.

### BRIEF SUMMARY OF THE INVENTION

So in that way, a method was imagined for placing a decoration and/or information support label on a molded package made of a biodegradable material, in particular paper pulp, of a type comprising a bottom and one or more peripheral wall(s), where further said information support does not constitute an obstacle to biodegradability.

This method allows decorating just a bottom or a bottom and one or more walls of the package with a single label.

This invention is particularly suited in the case of a paper label or a multilayer label comprising a paper layer.

The method for placing a decoration and/or information support label on at least the bottom of a package molded of natural fibers of a kind comprising a bottom and at least one peripheral wall, according to the invention, is characterized in that it consists of implementing the following successive operations:
supplying and possibly turning over said package, opening turned downward;
holding said package by the inside;
positioning and holding said label above said package, opening turned downward;
driving said package in displacement, and bringing the outside of the bottom thereof into contact with said label;
eliminating the holding of said label, where this operation could be done before the preceding step or after the following step;
indexing and spotwise securing of said label on said bottom;
moving said packaging and positioning the bottom thereof opposite means of activation of the securing process;
bringing said bottom and the label into contact with said activation means;
activating of the process for securing the label;
removing said labeled package.

According to an additional feature of the method according to the invention, the label comprises a part intended to cover at least a part of the outer wall of the package, and for this purpose the method comprises, before activation of the securing method, the following steps:
moving the packaging and positioning the bottom and the wall(s) thereof opposite means of activation of the securing process;
bringing said bottom and the label into contact with the activation means;
movement of other activation means towards said wall(s) of the package and application against the label.

The term “securing the label onto the package” means the action of sealing the label onto the package.

According to another additional characteristic of the method according to the invention, the holding of the package from the inside is done with aspiration.

According to an additional characteristic of the method according to the invention, the process of securing the label consists of a heat activatable adhesive and compression of the label against the package, where the label or at least one peripheral wall of the package is coated with adhesive, where the means of activation of the securing process consists of at least one plate, and where the application phase of the at least one plate against the label is followed by the following steps:
heating the at least one plate if it is not already at a defined temperature suited for activating the adhesive;
compressing the label against the package, withdrawing the at least one plate;
removal and possible cooling of said labeled package.

Here, the term “adhesive” indifferently designates an adhesive or glue, and more generally a solid, liquid or pasty substance, natural or synthetic, in a thin layer which once activated forms a generally very solid and permanent bond.

The term package designates in particular a jar, a container, but also a cover, plate or tray.

According to a variant of the method according to the invention, the activation of the adhesive by the at least one heating plate is combined with cooling from the inside of the wall(s) of the package.

According to a variant of the method according to the invention, the process of securing the label consists of an adhesive activatable by moisture, where the label or the peripheral wall(s) of the package is coated with an adhesive reactive with moisture or more generally with water.

According to another additional characteristic of the method according to the invention, the coating with adhesive is done prior to the method, or during it by an intermediate step of spraying or dipping.

It will be noted that the aforementioned examples of securing the label are not limiting, and that others may be implemented.

It should also be noted that the packaging conventionally has a generally parallelepiped shape, but it may also have a round section, and in that case the peripheral wall has a frustoconical shape, or any other shape.

An object of the present invention is also a tool with which to implement the method, and which is characterized in that it is made up of several stations with which to implement the various successive steps of the method, where the various stations are juxtaposed, with some at different levels, and in that they comprise:
at a level which could be lower, two stations for handling the package to be labeled, designed to be able to move said package vertically;
at a level which could be higher, on the one hand, vertical from one of said handling stations, a station for holding and positioning the label, and on the other hand vertical from the other handling station, a station for securing a label on said package;
and at a level which could be intermediate, a mobile tray, provided with an opening of dimensions suited for retaining from above said package while also allowing each of said means of handling to pass through it when said opening is brought opposite during the movement of said tray.

It will be noted that the mobility is relative, and that it is perfectly possible that it is the other elements, such as the various stations, which are mobile.

According to an additional characteristic of the tool according to the invention, the mobile tray comprises several openings.

The multiplication of the openings serves to simultaneously implement the various operations on several packages.

According to an additional characteristic of the tool according to the invention, the station for securing a label on said package comprises means, which could be mobile, designed to be able to receive in close contact the outside of the wall(s) and/or the bottom of the package, and incorporating means of activation of the securing process.

According to an additional characteristic of the tool according to the invention, the means of activation of the securing process consists of heating means.

According to another additional characteristic of the tool according to the invention, each of the handling stations comprises a vertically mobile platform supporting a support whose shape corresponds to the inside imprint of the package, at least to the bottom thereof.

According to another additional characteristic of the tool according to the invention, each of the handling stations comprises means for retaining a package by aspiration.

According to another additional characteristic of the tool according to the invention, the support of the handling station-to the vertical of which the station for securing a label is located—has an outer shape corresponding to the shape of the label to be applied to said package.

According to another additional characteristic of the tool according to the invention, the support of the handling station-to the vertical of which the station for securing a label is located-incorporates means complementary to the operation of the securing process.

Thus when the securing processes heated, the station for handling is intended to be able to be cooled so as to cool the package from the inside and thus reduce the unmolding time after the securing process is finished, and to regulate the temperature of the handling station in order to avoid overheating thereof.

The present invention also relates to a facility, which comprises several tools such as previously described, combined with devices for setting-up packages to be labeled and clearance of labeled packages.

The advantages and features of the method and the tool according to the invention will emerge more clearly from the description which follows and which relates to the appended drawing, which represents a non-limiting embodiment thereof.

### BRIEF DESCRIPTION OF THE SEVERAL VIEWS OF THE DRAWINGS

In the appended drawing:

FIGS. 1A, 1B, 1C, 1D, 1E and 1F show schematic views of successive steps of the method according to the invention.

FIGS. 2A, 2B, 2C, 2D, and 2E show schematic views of other successive steps of the same method.

FIG. 3 shows a partial perspective and exploded view of the implementation of a step from the same method.

FIG. 4 shows a perspective view of a tool according to the invention.

FIG. 5 shows a perspective view of an installation according to the invention.

### DETAILED DESCRIPTION OF THE INVENTION

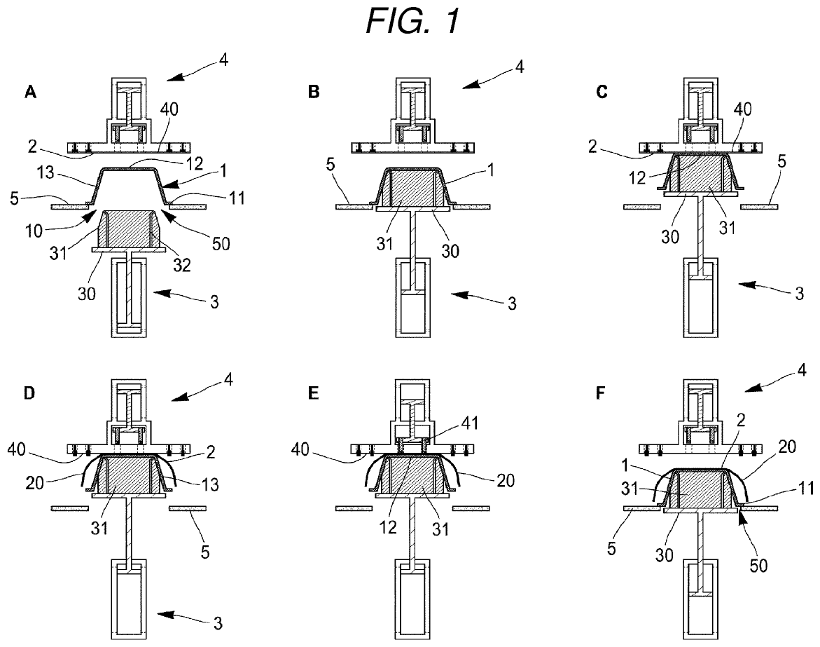

Referring to FIGS. 1A, 1B, 1C, 1D, 1E and 1F, a part of the tool can be seen with which to implement the first steps of the method according to the invention for placing a label 2 on a package 1.

This tool comprises a station 3 for handling a package 1, at a lower level; a station 4 for holding and positioning a label 2, at an upper level, vertical from the station 3; and a mobile tray 5 for support and movement of the package 1, at an intermediate level.

Here, the package 1 is arranged turned over on the tray 5, opening 10 directed downward and to the right of an opening 50 with transverse dimensions less than that of the opening 10 so as to be able to retain package 1 by the edges thereof 11.

The handling station 3 comprises a vertically mobile platform 30 on which is arranged a support 31 with a shape complementary to that inside the package 1, at least, in this case, conforming to the bottom part of the package, comprising the bottom 12 and the base of at least one peripheral wall 13. The platform 30 and the support 31 have transverse dimensions less than those of the opening 50 such that during a vertical translation the platform 30 and the support 31 can traverse the tray 5 in order to bring the package 1 which is waiting.

The handling of package 1 by the support 31 is advantageously completed by an aspiration system, represented by conduits 32.

The station 4 for holding and positioning a label 2 is seen in the form of a wall 40 with the dimensions and in the shape of a label 2 to be held, and which is associated with a system for retention by aspiration.

In FIG. 1A, the package 1 is arranged on the tray 5, with the opening 10 directed downward, to the right of the opening 50 above the handling station 3 and the support 31, and the label 2 is retained against the wall 40.

In FIG. 1B, the platform 30 lifts until the support 31 comes into contact with the inside of the package 1.

In FIG. 1C, the platform 30 continues rising and the support 31 applies the bottom 12 of the package 1 against the label 2 and the wall 40. The wall 40 may also, according to an additional characteristic of the invention, move in the direction of the platform 30, in addition to or instead of the movement of the platform 30.

In FIG. 1D, the retention of the label 2 by aspiration is stopped, such that the parts 20 of the label 2, intended to cover the at least one wall 13, fall by gravity thereon, whereas the label 2 is always held between the support 31 and the wall 40.

In FIG. 1E, the labeled 2 is indexed on the bottom 12 of the package 1. In this case, it is done by spot punching or welding by means of at least one hot punch 41 passing through the wall 40, which could also allow marking of information on the label 2 covering the package according to an additional characteristic of the invention.

It is of course possible to practice different ways to activate the adhesive points by, without limitation, heating, moistening, dampening and ultrasound.

In FIG. 1F, the platform 30 descends and places the package 1—on the bottom 12 of which the label 2 is indexed—on the platform 5 with the edges 11 thereof resting on the periphery of the opening 50.

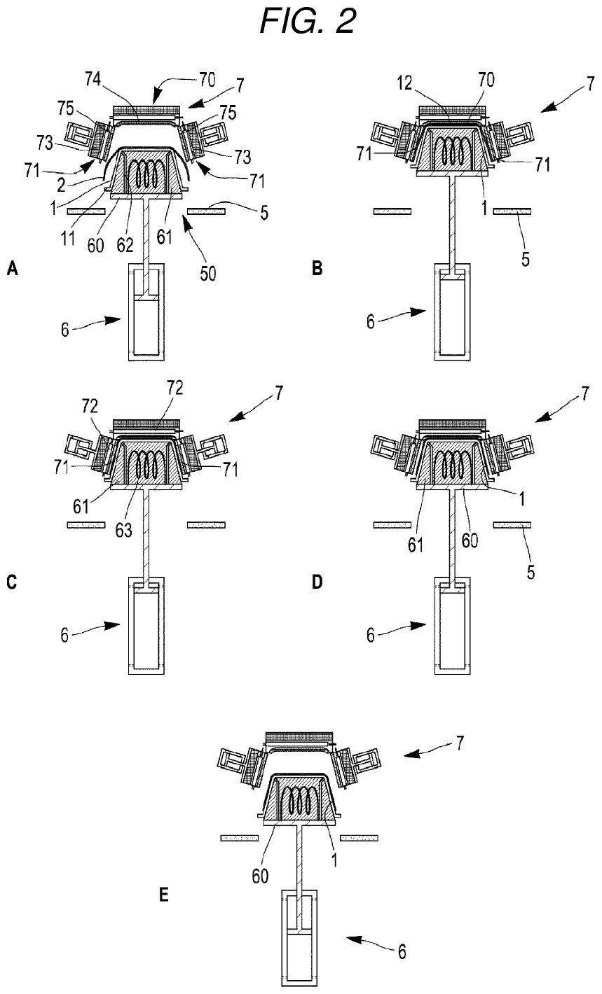

Referring now to FIGS. 2A, 2B, 2C, 2D and 2E, another part of the tool can be seen with which to implement the following steps of the method according to the invention.

In these figures, it can be seen that the tool comprises a station 6 for handling of a package 1, at a lower level; a station 7 for securing the label 2, at an upper level vertical from the station 6; and the tray 5 still extending at an intermediate level.

In a way practically similar to the handling station 3, the station 6 comprises a vertically mobile platform 60 on which is arranged a support 61 with a shape complementary to the internal shape of the package 1, and in this case, conforming to the whole of the package 1, meaning coming into contact with the entirety of the at least one peripheral wall 13 or at the very least with the shape of the label to be applied on said package. The platform 60 and the support 61 also have transverse dimensions less than those of the opening 50 such that during a vertical translation, the platform 60 and the support 61 can traverse the tray 5 in order to bring the package 1 which is waiting. There again, the handling of package 1 by the support 61 is advantageously completed by an aspiration system, represented by conduits 62.

The securing station 7 comprises a set of means designed to be able to receive the at least one wall 13 and the bottom 12 of the package 1 in close contact; in this case, it involves a fixed plate 70 intended to serve as a rest for the bottom 12, and mobile plate 71 able to be moved in direction from the at least one wall 13.

Further, the plates 70 and 71 incorporate means for activation of the securing process, which may be of different kinds.

In this case, preferably but without limitation, these plates 70 and 71 are heating, in order to activate an adhesive deposited on the label 1.

In practice, the plates 70 and 71 are each equipped with a resistance 72 combined with a conducting element inserted between an external insulating layer 73, and a covering intended to come into contact with the label 2, which for the plate 70 consists of a heat resistant and anti-adhesive covering 74 such as a polytetrafluoroethylene covering, known in particular under the tradename Teflon®, and for the plates 71 of a flexible covering 75 formed of silicone loaded with a thermally conducting material.

In FIG. 2A, the label 1 is taken by the support 61 from the platform 60 of the handling station 6 and moved vertically towards the securing station 7. Of course, the package 1 is the one coming from the preceding steps of the method according to the invention, and which was brought by displacement of the tray 5.

In FIG. 2B, the package 1 is inserted in the securing station 7 between the plates 71 and the bottom 12 thereof is pushed against the plate 70. The label 2 is naturally positioned near the intended place therefore, when the package 1 is inserted in the securing station 7.

In FIG. 2C, the plates 71 are moved towards the at least one peripheral wall 13 of the package 1 in order to push the label 2 against it, whereas the plates 70 and 71 are heated and that simultaneously the support 31 is cooled through an internal means such as a cooling circuit 63 through which a cooling liquid passes.

FIG. 2D, after activation of the adhesive and securing of the label 2, the plates 71 separate from the package 1, and then, FIG. 2E, the platform 60 moves away from the securing station, here towards the bottom, in order, in a first step, to extract the package 1 from the securing station, and then to place it on the tray in order for removal.

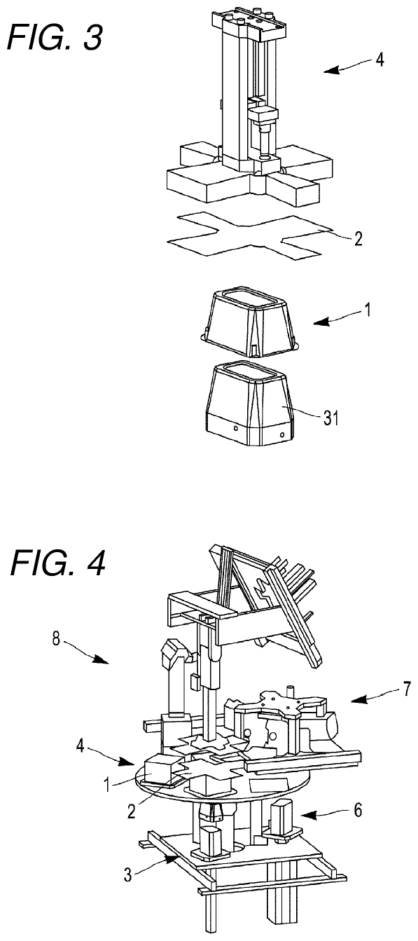

In FIG. 3 a part of the tool for implementing the process is shown; a package 1, a label 2, a station 4 for holding and positioning the label 2 and also a support 31 can be seen there.

The package shown is, without limitation, substantially parallelepiped shaped, which justifies the label having a cross shape, since each branch corresponds to a side of the package 1.

The package could however have a tubular shape, or more specifically a frustoconical shape could come from the molding; in this case the label 2 could have a round central part and one or more radial wings.

Further, as already brought up, the adhesive may be deposited on the label 2, or on the at least one wall 13 the package 1, before the process, like during the process by spraying or dipping for example, and possibly activation by moistening or dampening.

It will be noted that the various means with which to move the elements, such as the platforms 31 and 61, the punches 41 and the plate 71, preferably consist of cylinders, for example pneumatic or hydraulic.

Now referring to FIG. 4, a nonlimiting implementation of an installation 8 for implementing the method according to the invention can be seen.

The two stations 3 and 6 for handling a package, station 4 for holding and positioning a label 2, the securing station 7, and also the tray 5 provided with several openings can be seen there.

In this configuration, the tray 5 is mobile by pivoting around a central axis, and it turns for passing the packages 1 from station to station.

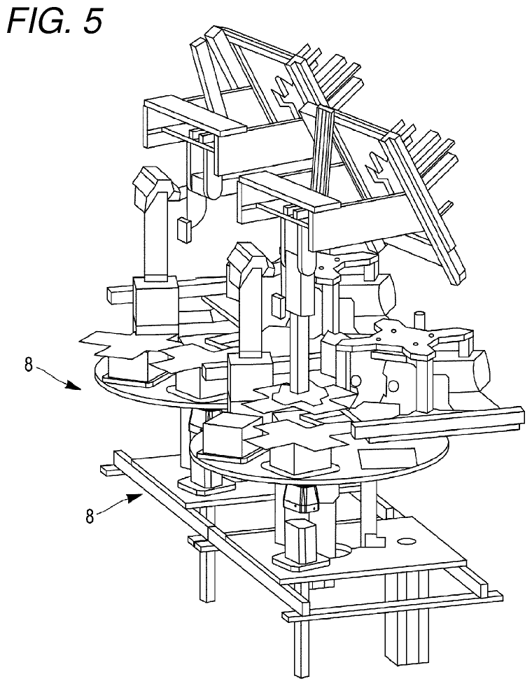

FIG. 5 shows two facilities 8 side-by-side, in the form of two carousels.

According to another embodiment of the invention not shown here, the process of spotwise securing the label 2 on the package 1 by the punches 41 is not initially done on the bottom, but spotwise on a first peripheral surface of the package 1, where this surface and possibly other surfaces of the package 1 are then secured or sealed during the securing process, by using a suitable securing tool, in a suitable securing installation, in order to get a package decorated with a label on at least one first peripheral surface of the package, and possibly on said other surfaces of the package 1.

According to another embodiment of the invention not shown here, the package 1 may be supplied by the opening directed upward or towards a side. The process of securing may be done according to movements in directions opposite to those described above, in particular when the package 1 is handled by a support 61 of the platform 60 of the handling station 6 and moved towards the securing station 7. The turning over of the package may also be only partial, with the opening of said package then being oriented laterally.

It is appropriate however to know that the fact of implementing the method according to the invention as shown on the figures serves to make securing the label 2 on the package 1 easier, since the label drops against the at least one peripheral wall of the package under the effect of gravity.

1. A method for placing a decoration and/or information support label on a package being molded of natural fibers and being comprised of a bottom and at least one peripheral wall, the method comprising the following steps:
supplying and possibly turning over said package, opening turned downward;
holding said package by the inside;
positioning and holding said label above said package, opening turned downward;
driving said package in displacement, and bringing the outside of the bottom thereof into contact with said label;
eliminating the holding of said label, where this step may be done before the preceding step or after the following step;
indexing and spotwise securing of said label on said bottom;
moving said packaging and positioning the bottom thereof opposite means of activation of the securing process;
bringing said bottom and the label into contact with said activation means;
activating of the process for securing the label; and
removing said labeled package.

2. The method according to claim 1, where the label comprises a part intended to cover at least a part of the outer wall of the package, the method further comprising, before activation of the securing method, the following steps:
moving the packaging and positioning the bottom and the wall(s) thereof opposite means of activation of the securing process;
bringing said bottom and the label into contact with the activation means; and
moving other activation means towards said wall(s) of the package and application against the label.

3. The method, according to claim 1, wherein the step of the indexing and spotwise securing of said label on said bottom is implemented by at least one punch.

4. The method, according to claim 1, wherein the step of indexing and spotwise securing the label comprises the steps of: coating the label or at least one peripheral wall of the package with a heat activatable adhesive, wherein the means of activation of the securing process comprises at least one plate, and wherein the application phase of the at least one plate against the label is followed by the following steps:
heating the at least one plate if it is not already at a defined temperature suited for activating the adhesive;
compressing the label against the package, withdrawing the at least one plate; and
removing said labeled package.

5. The method, according to claim 4, wherein the activation of the adhesive by the at least one heating plate is combined with a step of cooling from the inside of the walls of the package.

6. The method, according to claim 1, wherein the process of securing the label is comprised of an adhesive activatable by moisture, and wherein the label or the peripheral wall of the package is coated with an adhesive reactive with moisture.

7. A tool, comprising:
several stations with which to implement the various successive steps of the method, where the various stations are juxtaposed, with some at different levels, and in that they comprise: at a level which could be lower, two stations for handling the package to be labeled, designed to be able to move said package vertically; at a level which could be higher, on the one hand, vertical from one of said handling stations, a station for holding and positioning a label, and vertical from the other handling station, a station for securing a label on said package; and at a level which could be intermediate, a mobile tray, provided with an opening of dimensions suited for retaining from above said package while also allowing each of said means of handling to pass through it when said opening is brought opposite during the movement of said tray.

8. The tool, according to claim 7, wherein the station for securing a label on said package comprises means, which could be mobile, designed to be able to receive in close contact the outside of the wall and/or the bottom of the package, and incorporating means of activation of the securing process.

9. The tool, according to claim 7, wherein each of the handling stations comprises a vertically mobile platform supporting a support whose shape corresponds to the inside imprint of the package, at least to the bottom thereof.

10. The tool, according to claim 9, wherein the support of the handling station to the vertical of which the station for securing a label is located has an outer shape corresponding to the shape of the label to be applied to said package.

11. The tool, according to claim 10, wherein the support of the handling station to the vertical of which the station for securing a label is located incorporates means complementary to the operation of the securing process.

12. A package molded of natural fibers of a kind comprising a bottom and at least one peripheral wall comprising a label secured by implementing the method according to claim 1.
